(19) United States
(12) Patent Application Publication
(10) Pub. No.: US 2008/0267022 A1
(43) Pub. Date: Oct. 30, 2008

(54) Method and System With Focus Control for Scanning an Information Carrier

(75) Inventor: Levinus Pieter Bakker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/092,829

(22) PCT Filed: Nov. 7, 2006
(86) PCT No.: PCT/IB06/54132

§ 371 Date: May 7, 2008

(30) Foreign Application Priority Data
Nov. 11, 2005 (CN) 20010119486.1

(51) Int. Cl. G11B 7/00

(52) U.S. Cl. 369/44.23

(57) ABSTRACT

The invention relates to a method and system for reading data on a data layer (105) of an information carrier (101) comprising one or more servo marks (108, 109) positioned relative to said data layer (105), the system comprising: probe array generation means (104, 102) for generating a probe array comprising an array of light spots (103) intended to be applied to said information carrier (101) so as to generate output beams representative of said one or more servo marks (108, 109) and said data, wherein the distance between the focal point of one or more light spots of a portion of said probe array and a respective portion of said information carrier corresponding to at least one servo mark is different to the distance between the focal points of the light spots of the rest of the probe array and the rest of said information carrier; an image sensor (106) for receiving said output beams and generating a corresponding image; means (116) for deriving a contrast value in respect of at least of a portion of said image corresponding to said at least one servo mark (108, 109) and generating a control signal (125) derived from said contrast value, said control signal (125) being for application to actuation means (AC6) for adjusting the distance between said information carrier (101) and said array of light spots (103).

### FIELD OF THE INVENTION

The invention relates to a method and system with focus control for scanning an information carrier

The invention has applications in the field of optical data storage and microscopy.

### BACKGROUND OF THE INVENTION

The use of optical storage solutions is nowadays widespread for content distribution, for example in storage systems based on the DVD (Digital Versatile Disc) standards. Optical storage has a big advantage over hard-disc and solid-state storage in that the information carriers are easy and cheap to replicate.

However, due to the large amount of moving elements in the drives, known applications using optical storage solutions are not robust to shocks when performing read/write operations, considering the required stability of said moving elements during such operations. As a consequence, optical storage solutions cannot easily and efficiently be used in applications which are subject to shocks, such as in portable devices.

New optical storage solutions have thus been developed. These solutions combine the advantages of optical storage in that a cheap and removable information carrier is used, and the advantages of solid-state storage in that the information carrier is still and that its reading requires a limited number of moving elements.

FIG. 1 depicts a three-dimensional view of such an optical storage system aiming at generating control signals reflecting the spatial position of an information carrier 101 in a reading apparatus, and at adjusting said spatial position from said control signals.

The system comprises an optical element 102 for generating a periodic array of light spots 103 intended to be scanned and applied to the information carrier 101. The scanning is performed in moving the array of light spots over the information carrier. An input light beam 104 is applied at the input of the optical element 102. The input light beam 104 can be realized by a waveguide (not represented) for expanding an input laser beam, or by a two-dimensional array of coupled micro-lasers.

According to a first embodiment depicted in FIG. 2, the optical element 102 corresponds to a two-dimensional array 201 of micro-lenses at the input of which the coherent input light beam 104 is applied. The array of micro-lenses is placed parallel and distant from the information carrier 101 so as to focus the light spots at the surface of the information carrier 101. The numerical aperture (NA) and quality of the micro-lenses determines the size of the light spots. For example, a two-dimensional array of micro-lenses having a numerical aperture which equals 0.3 may be used.

According to a second embodiment depicted in FIG. 3, the optical element 102 corresponds to a two-dimensional array of apertures 301 at the input of which the coherent input light beam 104 is applied. The apertures correspond for example to circular holes having a diameter of 1 μm or much smaller.

In this second embodiment, the array of light spots 103 is generated by the array of apertures in exploiting the Talbot effect which is a diffraction phenomenon working as follows. When a number of coherent light emitters of the same wavelength, such as the input light beam 104, are applied to an object having a periodic diffractive structure, such as the array of apertures, the diffracted lights recombines into identical images of the emitters at a plane located at a predictable distance z0 from the diffracting structure. This distance z0, at which the information carrier 101 is placed, is known as the Talbot distance. The Talbot distance z0 is given by the relation z0=2·n·d²/λ, where d is the periodic spacing of the light emitters, λ is the wavelength of the input light beam, and n is the refractive index of the propagation space. More generally, re-imaging takes place at other distances z(m) spaced further from the emitters and which are a multiple of the Talbot distance z such that z(m)=2·n·m·d²/λ, where m is an integer. Such a re-imaging also takes place for m=½+an integer, but here the image is shifted over half a period. The re-imaging also takes place for m=¼+an integer, and for m=¾+an integer, but the image has a doubled frequency which means that the period of the light spots is halved with respect to that of the array apertures.

Exploiting the Talbot effect allows generating an array of light spots of high quality at a relatively large distance from the array of apertures (a few hundreds of μm, expressed by z(m)), without the need of optical lenses. This allows inserting for example a cover layer between the array of aperture and the information carrier for preventing the latter from contamination (e.g. dust, finger prints . . . ). Moreover, this facilitates the implementation and allows increasing in a cost-effect manner, compared to the use of an array of micro-lenses, the density of light spots which are applied to the information carrier.

Coming back to FIG. 1, the information carrier 101 comprises a data area 105 intended to store data coded at a multilevel, for example binary and ternary level. The data area 105 comprises adjacent elementary data areas organized as in a matrix. The elementary data areas are for example represented ad adjacent squares. The states of binary data stored on the elementary data areas 105 are for example represented by transparent, or non-transparent areas (i.e. light-absorbing). The elementary data areas are printed on a material such as glass or plastic.

The light spots are applied on the elementary data areas of the information carrier 101. If a light spot is applied on a non-transparent elementary data area, no output light beam passes through the information carrier. On the contrary, if a light spot is applied on a transparent elementary data area, it passes through the information carrier and can be detected afterwards by a detector 106 placed above the information carrier 101.

Each light spot is applied and scanned over a partial area of the data area 105. The scanning of the information carrier 101 is performed in displacing the array of light spots 103 along x and y axis.

The detector 106 is notably used for detecting the binary value of the elementary data areas on which the optical spots are applied. To this end, the detector 106 comprises a data detection area 107 opposite the data area 105 of the information carrier, in parallel planes.

The detector 106 is for example made of an array of CMOS or CCD pixels. Advantageously, one pixel of the detector is intended to detect a set of elementary data, each data among this set of elementary data being successively read by a single light spot. This way of reading data on the information carrier 101 is called macro-cell scanning in the following and will be described after.

FIG. 4 depicts a cross-section and detailed view of the data area 105 of the information carrier 101, and the data detection area 107 of the detector 106. The detector 106 comprises pixels referred to as PX1-PX2-PX3, the number of pixels shown being limited for facilitating the understanding. In particular, pixel PX1 is intended to detect data stored on the data area A1 of the information carrier, pixel PX2 is intended to detect data stored on the data area A2, and pixel PX3 is intended to detect data stored on the data area A3. Each data area, also called macro-cell, comprises a set of elementary data. For example, data area A1 comprises four elementary data referred to as A1a-A1b-A1c-A1d.

FIG. 5 illustrates by an example the macro-cell scanning of an information carrier 101. Data stored on the information carrier have two states indicated either by a black area (i.e. non-transparent) or white area (i.e. transparent). For example, a black area corresponds to a “0” binary state while a white area corresponds to a “1” binary state. When a pixel of the detector is illuminated by an output light beam generated by the information carrier 101, the pixel is represented by a white area. In that case, the pixel delivers an electric output signal (not represented) having a first state. On the contrary, when a pixel of the detection area 107 does not receive any output light beam from the information carrier, the pixel is represented by a cross-hatched area. In that case, the pixel delivers an electric output signal (not represented) having a second state.

In this example, each set of data comprises four elementary data, and a single light spot is applied simultaneously to each set of data. The scanning of the information carrier 101 by the array of light spots 103 is performed for example from left to right, with an incremental lateral displacement which equals the distance S between two elementary data.

In position A, all the light spots are applied to non-transparent areas so that all pixels of the detector and in the second state.

In position B, after displacement of the light spots to the right, the light spot to the left side is applied to a transparent area so that the corresponding pixel is in the first state, while the two other light spots are applied to non-transparent areas so that the two corresponding pixels of the detector are in the second state.

In position C, after displacement of the light spots to the right, the light spot to the left side is applied to a non-transparent area so that the corresponding pixel is in the second state, while the two other light spots are applied to transparent areas so that the two corresponding pixels of the detector are in the first state.

In position D, after displacement of the light spots to the right, the central light spot is applied to a non-transparent area so that the corresponding pixel is in the second state, while the two other light spots are applied to transparent areas so that the two corresponding pixels of the detector are in the first state.

The scanning of the information carrier 101 is complete when the light spots have been applied to all data of a set of data facing a pixel of the detector. It implies a two-dimensional scanning of the information carrier. Elementary data which compose a set of data opposite a pixel of the detector are read successively by a single light spot.

The scanning of the information carrier by the array of light spots 103 is done in a plane defined by axis x and y, parallel to the information carrier 101. A scanning device provides translational movement in the two directions x and y for scanning all the surface of the information carrier.

In general, the probe generation device and the data card are assumed to be positioned in planes perpendicular to the z-axis. The data layer is positioned in the plane z=z₀. At certain positions on the data card, the probes are focused at a different distance from the probe generation device. For instance, a first part of the probes has its focus at z=z₀−Δz. By measuring the contrast in both the first and second part, expressing it in some quantity C₁ and C₂, and taking the difference of these two contrast values, we have a measure for the defocus.

The following table 1 shows three different situations.

| C₁ − C₂ | Position data card |
|---|---|
| <0 | z too high |
| =0 | z correct |
| >0 | z too low |

The information carrier 101 also comprises a first periodic structure 108, and a second periodic structure 109. The first and second periodic structures are for example printed or glued on the information carrier. The periodic structures 108 and 109 are composed of transparent and non-transparent parallel stripes.

The first periodic structures 108 is intended to interfere with the periodic array of light spots 103 for generating a first Moiré pattern on an area 110 of the detector 106. The first Moiré pattern is only generated by the subset of light spots taken among the period array of light spots 103 which is opposite the first periodic structures 108. The first periodic structures 108 and the area 110 are opposite.

The second periodic structures 109 is intended to interfere with the periodic array of light spots 103 for generating a second Moiré pattern on an area 111 of the detector 106. The second Moiré pattern is only generated by the subset of light spots taken among the periodic array of light spots 103 which is opposite the second periodic structures 109. The second periodic structures 109 and the area 111 are opposite.

These Moiré servo marks are used to accurately position the light spots relative to the information carrier.

In practice it may occur that the light spots are not perfectly focussed, to the detriment of the data reading in the data area 105. It is thus an important issue to measure the focus, and vary accordingly along axis z the distance between the information carrier 101 and the optical element 102 generating the array of light spots 102. This known solution describes how the Moiré servo marks on the data card can be used for focus detection. The Moiré servo marks generate a Moiré magnified image of the spot. The size of this image is minimal, and the contrast is maximal when the data layer is in the focal plane of the spots.

However, the end signal is unidirectional in the sense that it does not give information on whether a negative or positive correction of the position of the data card is necessary. The positioning of the information carrier is thus not reliable.

### OBJECT AND SUMMARY OF THE INVENTION

Thus, it is an object of the present invention to provide a method and system for accurately and reliably positioning an information carrier with respect to an array of light spots in a scanning and/or writing apparatus.

In accordance with the present invention, there is provided a method and system for scanning an information carrier comprising one or more servo marks, the system comprising:
probe array generation means for generating a probe array comprising an array of light spots intended to be applied to said information carrier so as to generate output beams representative of said one or more servo marks, wherein the distance between the focal point of one or more light spots of a portion of said probe array and a respective portion of said information carrier corresponding to at least one servo mark is different to the distance between the focal points of the light spots of the rest of the probe array and the rest of said information carrier;
an image sensor for receiving said output beams and generating a corresponding image;
means for deriving a contrast value in respect of at least a portion of said image corresponding to said at least one servo mark and generating a control signal derived from said contrast value, said control signal being for application to actuation means for adjusting the distance between said information carrier and said array of light spots.

By having a dedicated part of the probe array at a different plane relative to a servo mark to that of the probes for the scanning of other information, a bi-directional error signal can be obtained for controlling the focus of the light spots applied to the information carrier. In other words, a control signal having a sign associated is provided therewith to indicate the direction in which focus control is required to be performed.

### BRIEF DESCRIPTION OF THE DRAWINGS

Embodiments of the present invention will now be described by way of example only and with reference to the accompanying drawings, in which:

FIG. 1 depicts an information carrier reading system;

FIG. 2 depicts an optical element for use in a first exemplary embodiment of the system of FIG. 1;

FIG. 3 depicts an optical element for use in a second exemplary embodiment of the system of FIG. 1;

FIG. 4 depicts a detailed view of the system of FIG. 1;

FIG. 5 illustrates the principle of macro-cell scanning used in the system of FIG. 1;

FIG. 6 depicts a first information carrier;

FIG. 7 illustrates by a first example said first information carrier of FIG. 6;

FIG. 8 illustrates by a second example said first information carrier of FIG. 6;

FIG. 9 depicts a second information carrier;

FIG. 10 depicts a third information carrier;

FIG. 11 illustrates by a first example said third information carrier of FIG. 10;

FIG. 12 illustrates by a second example said third information carrier of FIG. 10;

FIG. 13 depicts a fourth information carrier;

FIG. 14 depicts a fifth information carrier;

FIG. 15 illustrates by a first example said fifth information carrier of FIG. 14;

FIG. 16 illustrates by a second example said fifth information carrier of FIG. 14;

FIG. 17 depicts a sixth information carrier;

FIG. 18 is a schematic diagram illustrating a first exemplary embodiment of the invention;

FIG. 19 is a schematic diagram illustrating a second exemplary embodiment of the invention;

FIG. 20 is a schematic diagram illustrating a third exemplary embodiment of the invention; and

FIG. 21 depicts the control-loops for the system of FIG. 1.

### DETAILED DESCRIPTION OF THE INVENTION

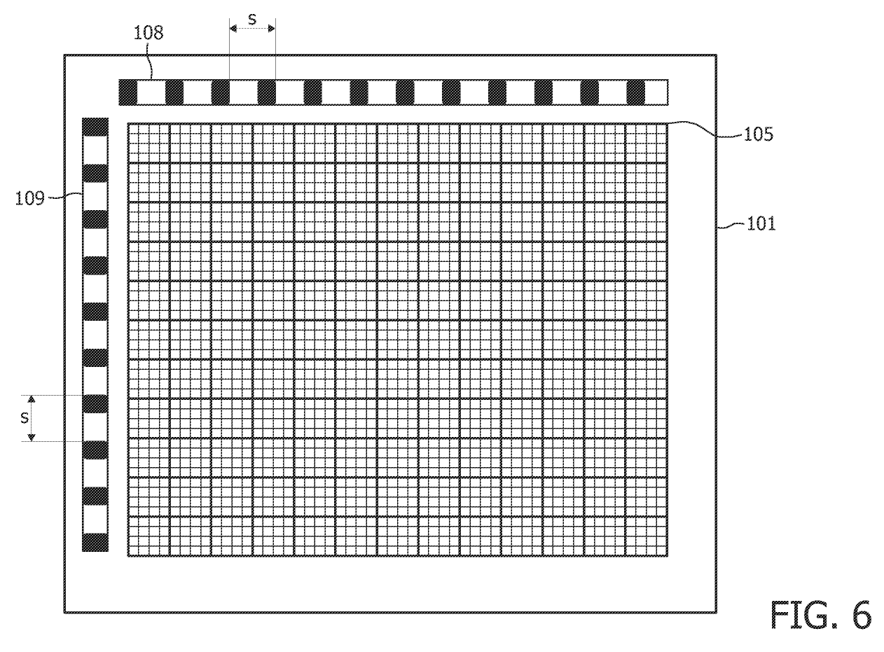

By way of background, and referring to FIG. 6 of the drawings, there is depicted the top view of an information carrier 101 comprising a first periodic structure 108 and a second periodic structure 109 placed perpendicularly. Each periodic structure is made of parallel stripes having a period referred to as “s” (it is noted that the first period of the first periodic structure 108 and the period of the second periodic structure 109 could be different). The data area 105 is made of adjacent macro-cells (squares in bold lines), each macro-cell comprising a set of elementary data areas (sixteen elementary data areas are represented in this example). Each macro-cell is intended to be scanned by one light spot.

The Moiré effect is an optical phenomenon which occur when an input image with a structure having a period s (i.e. the periodic structure 108 or 109 in the present case) is sampled with a periodic sampling grid having a period p (i.e. the periodic array of light spots 103 in the present case) which is close or equal to the period s of the input image, which results in aliasing. The sampled image (i.e. the Moiré pattern) is magnified and rotated compared to the input image.

It can be shown that the magnification factor μ of the Moiré pattern, and the angle φ between the Moiré pattern and the periodic structure are expressed as follows:

$$\begin{matrix}μ = \frac{p}{\sqrt{p cos θ - {s}^{2} + {( p sin θ )}^{2}}} & ( 1 ) \\ tan φ = \frac{p sin θ}{p cos θ - s} & ( 2 )\end{matrix}$$

where
p is the period of the array of light spots 103,
s is the period of the periodic structure 108 or 109,
θ is the angle between the period array of light spots 103 and the period structure.

For a situation without angular misalignment between the array of light spots 103 and the periodic structure 108 or 109 (i.e. with an angle θ=0), the magnification factor μ0 is expressed as follows:

$$μ 0 = \frac{p}{\vert p - s \vert} \qquad ( 3 )$$

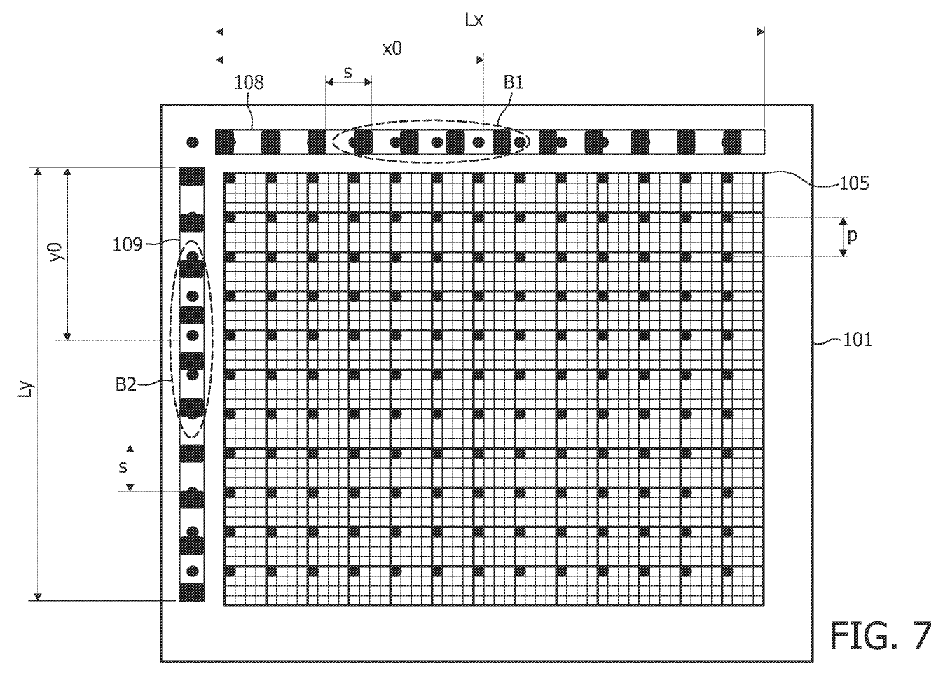

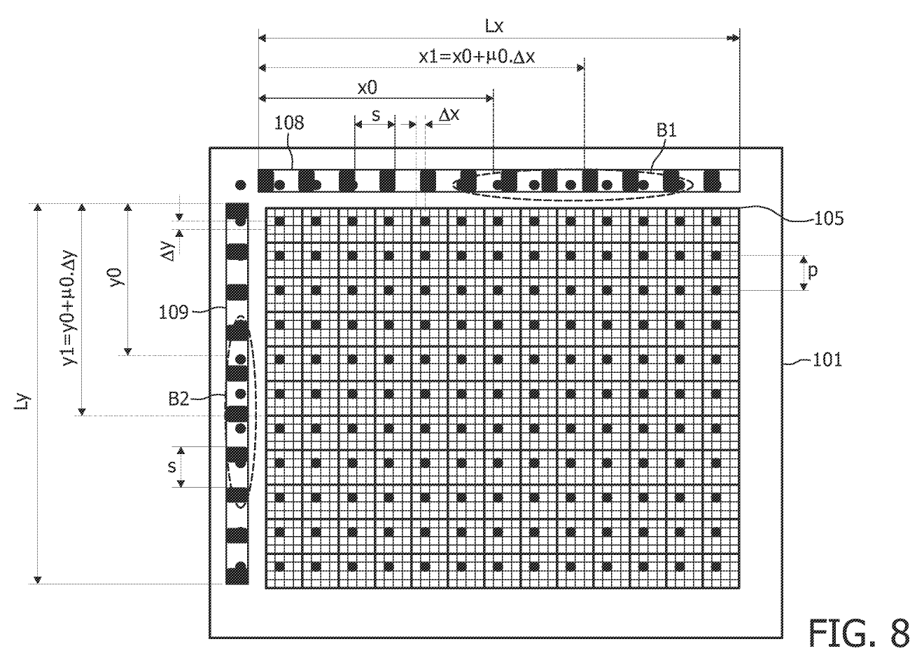

FIGS. 7 and 8 illustrate the generation of Moiré patterns. They show the information carrier 101 on which is applied the array of light spots 103 having a period referred to as “p” in both directions. The light spots are not only applied on each macro-cell of the data area 105, but also on the periodic structures 108 and 109. The period p equals the side of the macro-cells. Because of the difference between the period p and the period s of the structures 108 and 109, the first periodic structure 108 and the second periodic structure 109 are magnified, and detected o the detection area 110 and 111, respectively. In this example, s and p are chosen so that the ratio s/p=11/10, leading to a magnification factor μ0=10.

FIG. 7 represents an initial position of the scanning of the information carrier in which each light spot is to be positioned in the upper left corner of each macro-cell. The first periodic structure 108 is magnified, and the corresponding first Moiré pattern comprises a first light blob B1. The first light blob B1 corresponds to the magnification of the transparent stripes located between two adjacent non-transparent stripes of the periodic structure 108. The second periodic structure 109 is also magnified, and the corresponding second Moiré pattern comprises a second light blob B2. The second light blob B2 corresponds to the magnification of the transparent stripes located between two adjacent non-transparent stripes of the periodic structure 109.

To accurately position each light spot in the upper left corner of each macro-cell, the array of light spots 103 is moved until the first light blob B1 is positioned at a known distance x0 from the left side of the detection area 110, and until the second light blob B2 is positioned at a known distance y0 from the upper side of the detection area 111. Distance x0 and distance y0 are known from design.

When the array of light spots is moved horizontally for reading a next set of elementary data areas, the first light blob B1 is moved horizontally. When the array of light spots is moved vertically for reading a next set of elementary data areas, the second light blob B2 is moved vertically.

For scanning purpose, considering that the array of light spots 103 is to be moved horizontally to the right by a quantity k1·Δx, and is to be moved vertically to the bottom by a quantity k2·Δy, where Δx corresponds to the distance between two horizontal adjacent elementary data areas, where Δy corresponds to the distance between two vertical adjacent elementary data areas, where k1 is an integer verifying 1≦k1≦k1_max (k1=1 in this example), where k1_max corresponds to the number of elementary horizontal shifts necessary for scanning horizontally a macro-cell (k1_max=3 in this example), k2 is an integer verifying 1≦k2≦k2_max (k2=1 in this example), where k2_max corresponds to the number of elementary vertical shifts necessary for scanning vertically a macro-cell (k2_max=3 in this example), the targeted position of the light spots is reached when the following conditions are fulfilled:
the position of the first light blob B1 is detected at a distance x1=(x0+μ0·k1·Δx) from the left side of the detection area 110, and
the position of the second light blob B2 is detected at a distance y1=(y0+μ0·k2·Δy) from the upper side of the detection area 111.

To facilitate the location of the light blobs on the detection areas, it is advantageous to generate only one light blob along the length L (L=Lx, or L=Ly) of a given detection area. It can be shown that for having one light blob, the periods s and p have to verify the following relation:

$$\vert p - s \vert = \frac{{p}^{2}}{L} \qquad ( 4 )$$

The periods s and p are also chosen so that the distance x1=(x0+μ0·k1_max·Δ1=(y0+μ0·k2_max Δy) do not exceed Lx and Ly, respectively.

Advantageously, the width of the periodic structures 108 and 109 is at least as large as the period p of the array of light spots 103 so that when the array of light spots is scanned over the information carrier 101, there is always a subset of light spots which may interfere with the periodic structures for creating Moiré patterns.

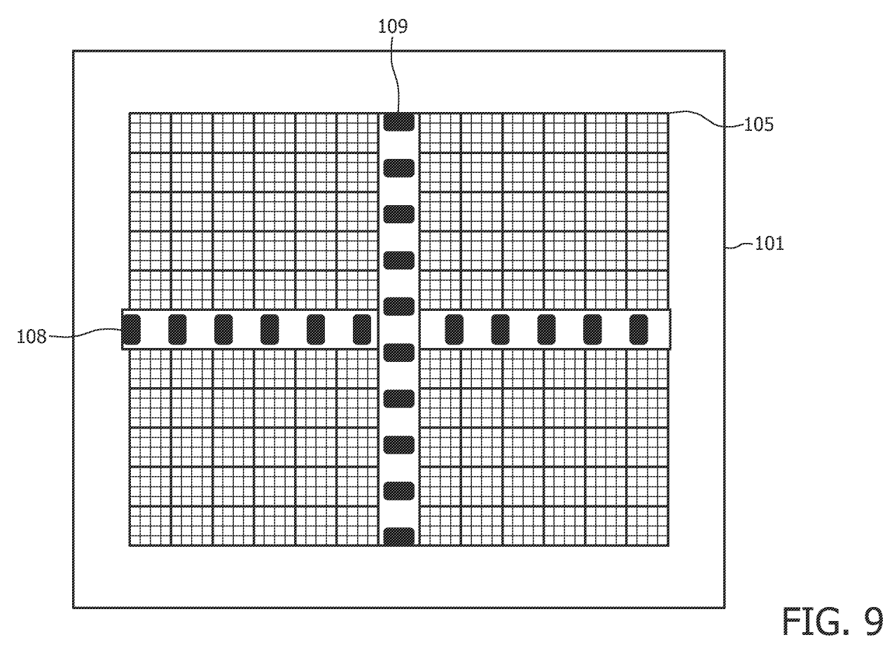

Alternatively, as depicted in FIG. 9, the first and second periodic structures 108 and 109 are arranged according to a cross inside the data area 105. The corresponding detection areas 110 and 111 are also arranged according to a cross inside the detection area 107.

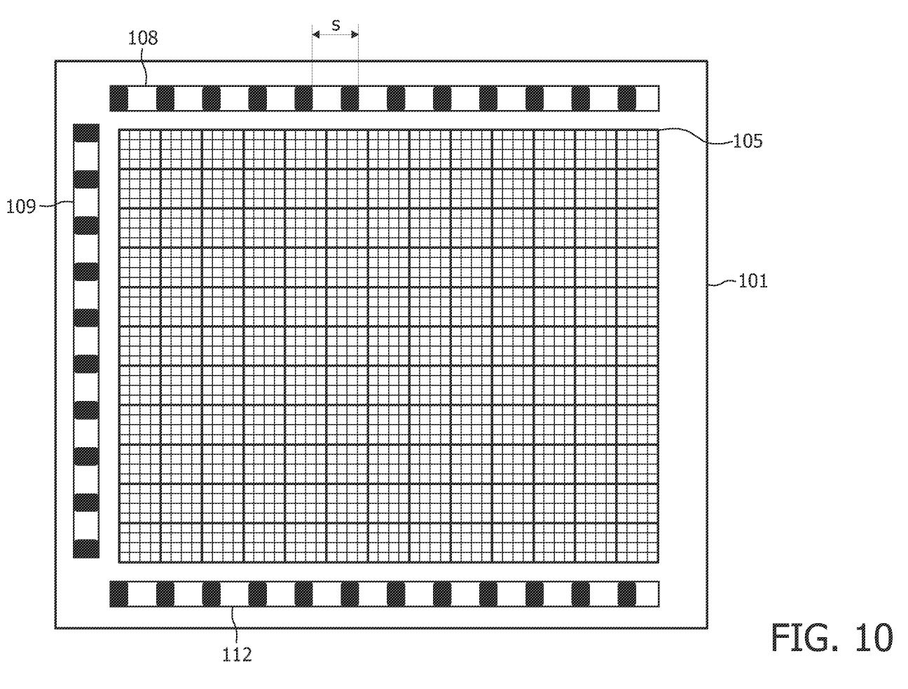

FIG. 10 depicts a top-view of an information carrier 101 having the same characteristics as the information carrier depicted in FIG. 6, but additionally comprising a third periodic structure 112 intended to interfere with said periodic array of light spots for generating a third Moiré pattern on a detection area 113 of the detector 106. The third periodic structure 112 is identical to the first periodic structure 108, is placed at the periphery of said data area 105, and is arranged parallel and opposite to said first periodic structure 108.

The first Moiré pattern and the third Moiré pattern are intended to give information on an angular misalignment between the periodic array of light spots 103 and the information carrier 101.

Since one light spot has to be applied on the same elementary data area in each macro-cell, the detection and correction of angular misalignment is an important issue to be done before performing a read or a write operation on the data area.

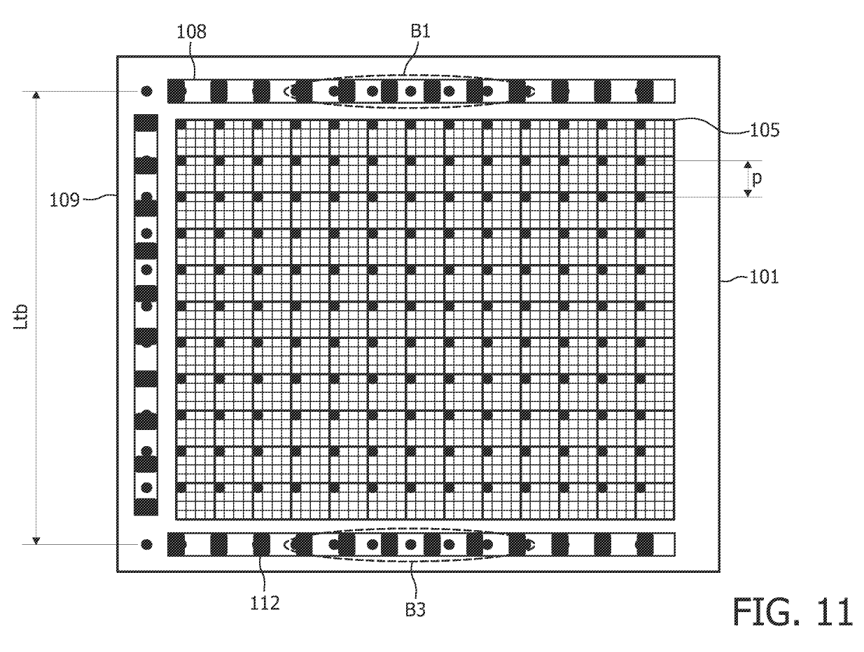

As illustrated by FIG. 11, when there is no misalignment between the array of light spots and the information carrier 101, the first Moiré pattern comprises a first light blob B1, and the third Moiré pattern comprises a third light blob B3. The light blobs B1 and B3 are vertically aligned.

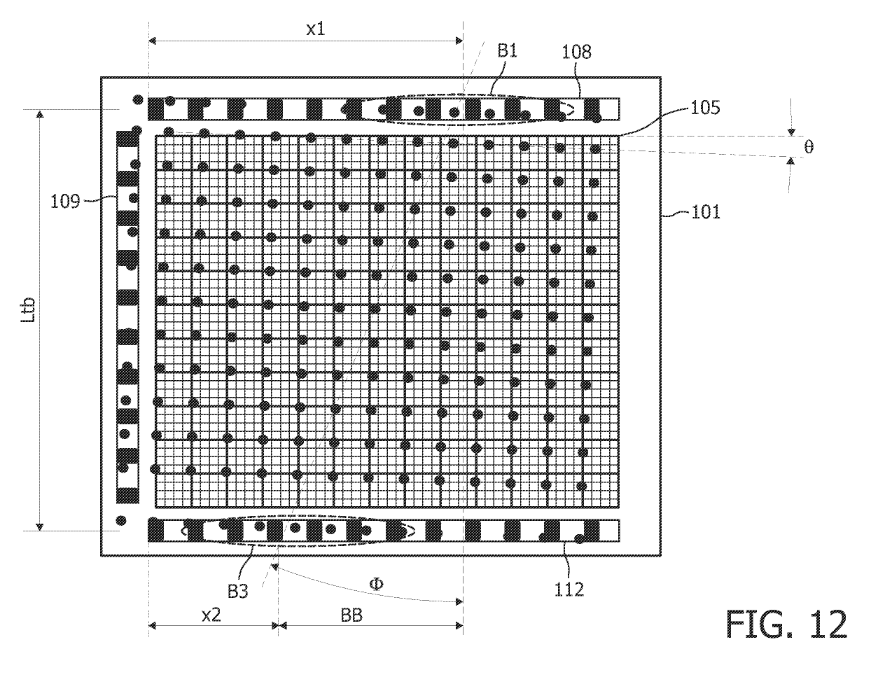

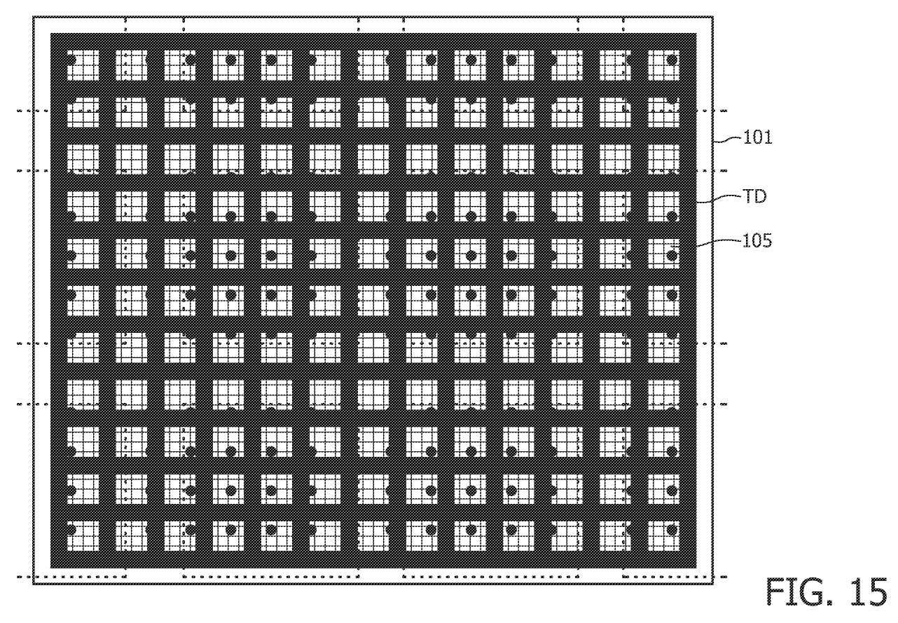

As illustrated in FIG. 15, when a misalignment between the array of light spots and the information carrier 101 occurs (2 degrees in this example), the first light blob (B1 is shifted horizontally, and the third light blob B3 is also shifted horizontally. If the centre of rotation is in between 108 and 112 (as illustrated by FIG. 12), the light blobs B1 and B3 are shifted horizontally in an opposite direction. On the contrary, if the centre of rotation is beyond 108 and 112, the light blobs B1 and B3 are shifted horizontally in the same direction but in unequal amounts.

From (2), if the misalignment angle θ is small (i.e. not larger than a few degrees), it can be shown that the misalignment angle θ may be derived from the following relation:

$$θ = \frac{BB}{μ \cdot Ltb} \qquad ( 5 )$$

where
   Ltb is the vertical distance between the first periodic structure 108 and the second periodic structure 109,
   BB is the vertical shift between the first light blob B1 and the second light blob B2,
   μ is the magnification factor as defined by (3).

The sign of angle θ is given by the sign of the difference (x1−x2), where x1 is the position of the first light blob B1 measured from the left side of the detection area 110, and where x2 is the position of the third light blob B3 measured from the left side of the detection area 112.

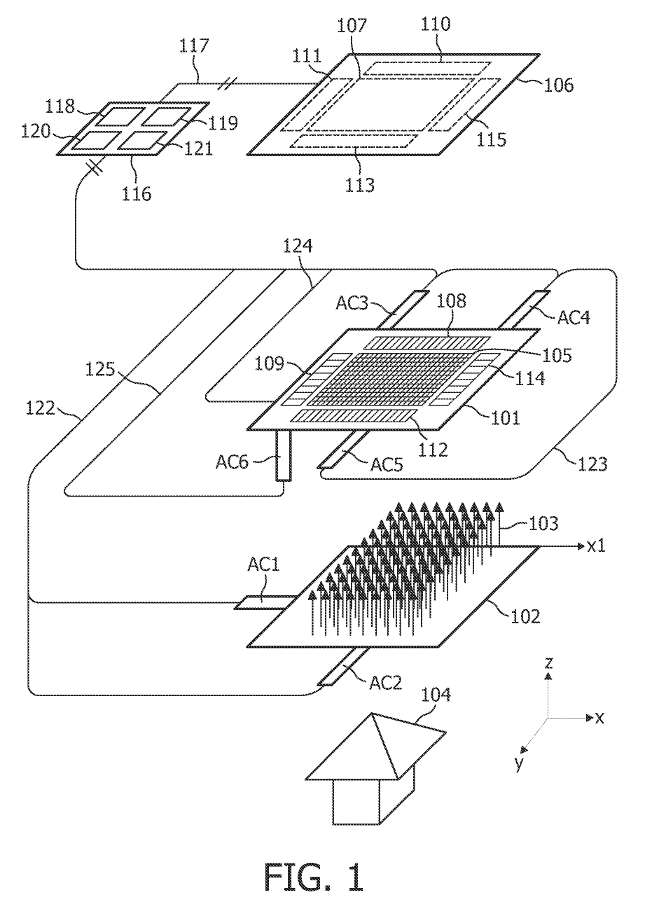

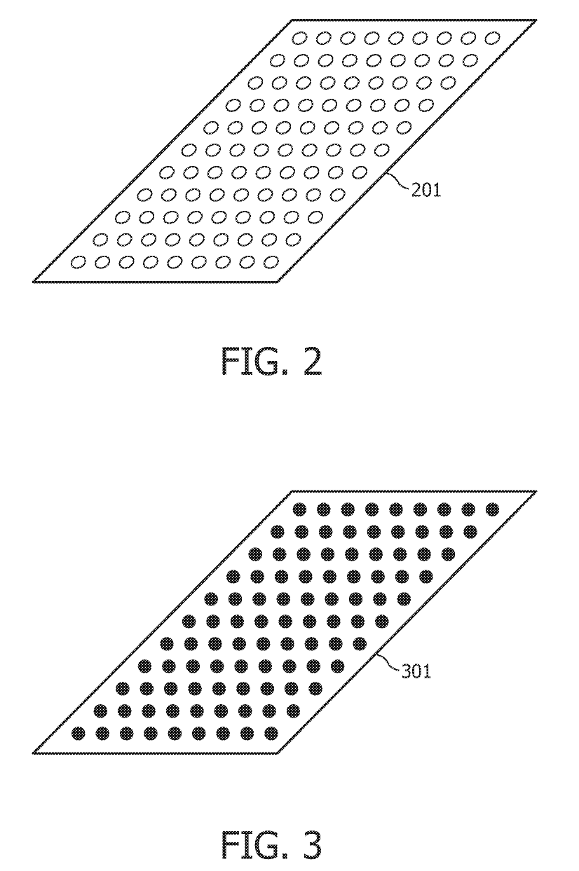

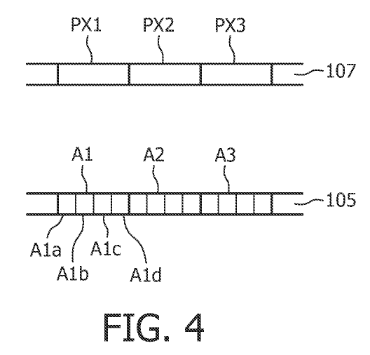

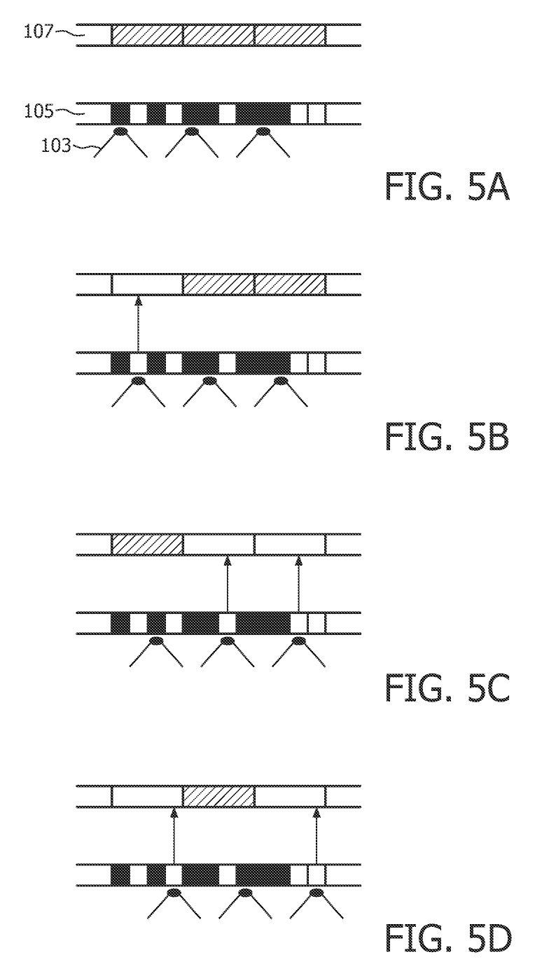

To perform the correction of the angular misalignment, the system of FIG. 1 comprises actuation means AC3-AC4-AC5 (e.g. piezoelectric actuators) for adjusting the angular position of said information carrier 101 with respect to said array of light spots 103. They are controlled by control signals 123 derived from said angle θ.

In a first embodiment depicted in FIG. 1, the actuation means AC3-AC4-AC5 are in contact with the periphery of the information carrier 101. In this case, the array of light spots 103 is fixed, while the information carrier 101 may rotate under the control of said actuation means, until cancelling the angular misalignment.

Alternatively, in a second embodiment (not depicted), the actuation means AC3-AC4-AC5 are in contact with the periphery of the optical element 102 generating the array of light spots 103. In this case, the information carrier 101 is fixed, while the array of light spots 103 may rotate under the control of said actuation means, until cancelling the angular misalignment.

The use of three actuators AC3-AC4-AC5 is sufficient for rotating the information carrier 101 (or the optical element 102) around the vertical axis z, so as to correct the angular misalignment θ.

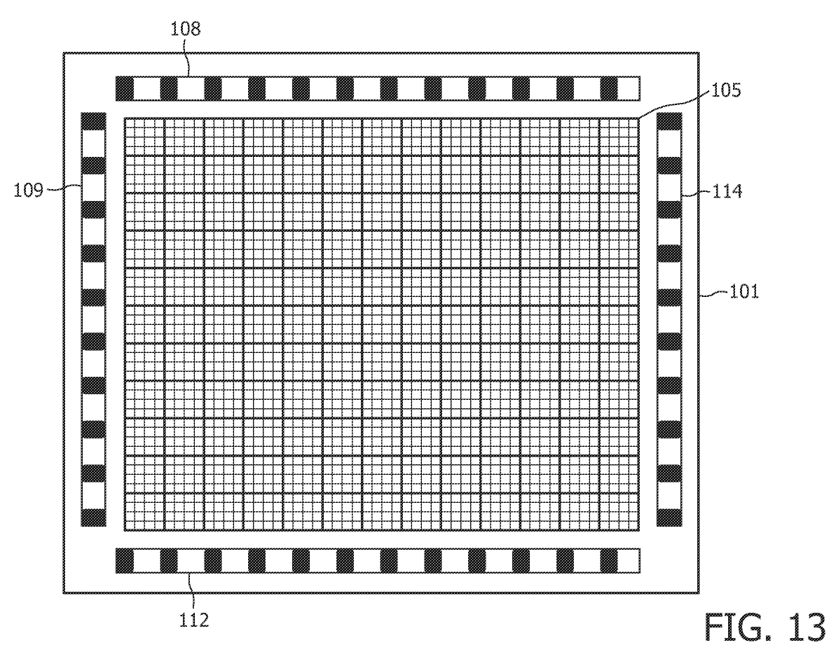

FIG. 13 depicts a top-view of an information carrier 101 having the same characteristics as the information carrier depicted in FIG. 10, but additionally comprising a fourth periodic structure 114 intended to interfere with said periodic array of light spots for generating a fourth Moiré pattern on a detection area 115 of the detector 106. Similarly as for the second Moiré pattern, the fourth Moiré pattern comprises a fourth light blob B4 (not illustrated).

The fourth periodic structure 109 is identical to said second periodic structure 109, placed at the periphery of the data area 105, and arranged parallel and opposite to said second periodic structure 109.

The fourth Moiré pattern may be used for improving the robustness in the measurement of the angular misalignment. Indeed, a first measure of the misalignment angle θ may be derived from said first and third Moiré pattern in using relation (5) as explained previously, and a second measure of the misalignment angle may be derived from said second and fourth Moiré pattern similarly. The average of these two intermediate measures is performed to derive a measure of the misalignment angle θ.

It is noted that the third Moiré pattern, similarly as the first Moiré pattern, may also be used for measuring the horizontal shift between the array of light spots and the information carrier.

It is noted that the fourth Moiré pattern, similarly as the second Moiré pattern, may also be used for measuring the vertical shift between the array of light spots and the information carrier.

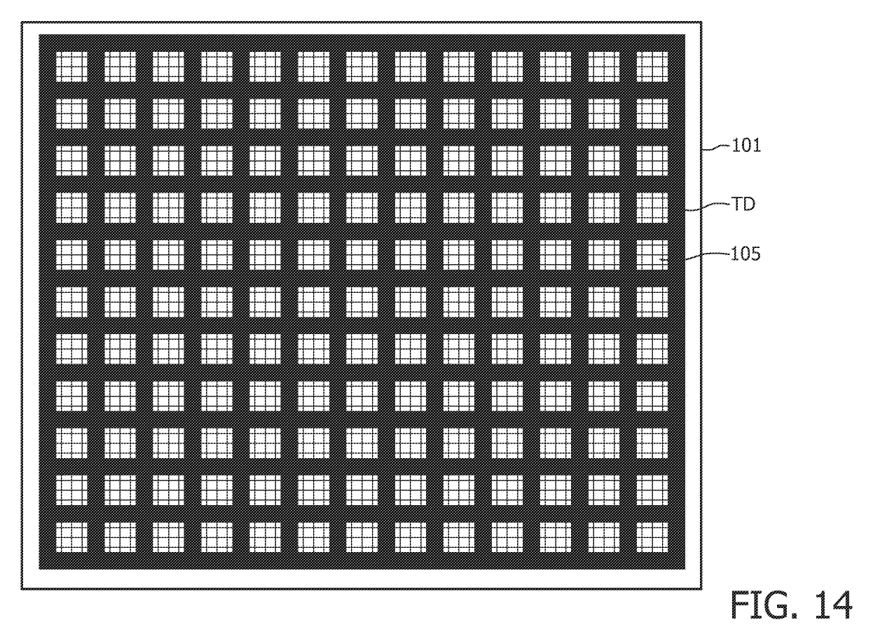

FIG. 14 depicts a top-view of an information carrier 101 intended to be read and/or written by the periodic array of light spots 103.

The information carrier 101 comprises a data area 105 defined by a set of elementary data areas, and organized in macro-cells as previously described.

The information carrier 101 also comprises a two-dimensional periodic structure TD intended to interfere with the periodic array of light spots for generating a global Moiré pattern on the detection area 107 of the detector 106. This two-dimensional periodic structure is intermingled with said elementary data areas. The global Moiré pattern to be detected on the detection area 107 is thus also intermingled with the data. However, since the data are a priori random, a periodic pattern may easily be detected in the detection area 107, for example in using known matching algorithms.

As illustrated in FIG. 14, the two-dimensional periodic structure TD defines a grid formed by vertical and parallel stripes (having a width twice larger than the size of an elementary data area in this example), and by horizontal and parallel stripes (having a width twice larger than the size of an elementary data area in this example). As illustrated in FIG. 15, the corresponding Moiré pattern is also a grid which is magnified (represented also with squares in dotted lines for facilitating the understanding).

The horizontal position of the magnified grid may be used for determining the horizontal position between the information carrier and the array of light spots, while the vertical position of the magnified grid may be used for determining the vertical position between the information carrier and the array of light spots, similarly as the tracking of light blobs B1 and B2 described previously.

In case of an angular misalignment between the information carrier and the array of light spots, the Moiré pattern is also rotated according to (2).

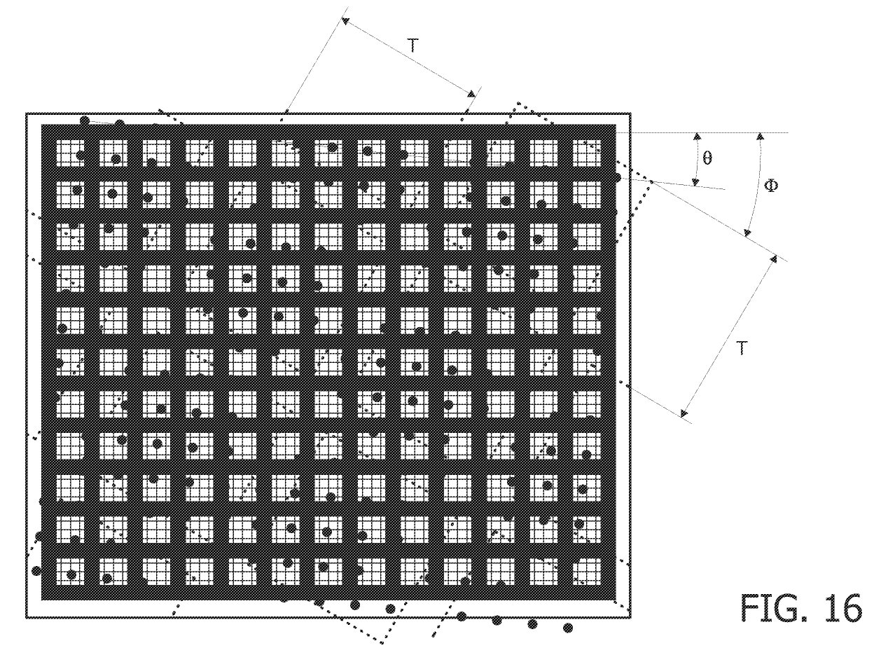

FIG. 16 illustrates the case with a misalignment θ of 5 degrees. It can be shown from (2) that the angular misalignment θ may be derived from the following relation:

$$tan φ = \frac{p sin φ}{p cos φ + T} \qquad ( 6 )$$

where T is the period of the global Moiré pattern detected on the detection area 107.

Coming back to FIG. 1, the system also comprises a processing unit 116 intended to perform calculations from the different Moiré patterns detected and generated by the detector 106, and carried as signals via a data bus 117. The processing can be done by code instructions stored in a memory and executed by a signal processor. In particular, the processing unit 113 comprises:
first analysis means 118 for deriving from said first and second Moiré patterns, the spatial position (x,y) between the periodic array of light spots 103 and said information carrier 101. Analysis means 118 are in charge of detecting the position of the light blobs B1 and B2 along the detection areas 110 and 111 respectively. To this end, known tracking algorithms may be used.
second analysis means 119 for deriving from said first and third Moiré patterns, and/or from said second and fourth Moiré patterns, the angle value θ between said periodic array of light spots 103 and said information carrier 101. Analysis means 119 are in charge of detecting the position of the light blobs B1, B2, B3 and B4 along the detection areas 110, 11, 113 and 115, respectively (in using for example known tracking algorithms), and to derive the angle value θ from relation (5).
From (2), the period of the periodic structures 108, 109, 112 or 114 may be derived from the relation:

$$s = p cos θ - \frac{p sin θ}{tan φ} \qquad ( 7 )$$

If the misalignment angle θ is accurately known, for example from relation (6), relation (7) allows to derive a measure of the period s of the considered periodic structure.

The processing unit 116 thus comprises third analysis means 120 for deriving from (7) a measure of the period s of said first, second, third or fourth periodic structure (108, 109, 112, 114), from the period p of said periodic array of light spots 103, the angle value θ, and the measured angle φ between said first, second, third or fourth periodic structure (108, 109, 112, 114), and said first, second, third or fourth Moiré patterns.

If the measured period s is different than a targeted and known period s0, for example because of a temperature change, it can be assumed that a shift will occur between the light spots and the macro-cells. The measure of the period s is thus advantageously used for controlling the size of the macro-cells with respect to the period p of the light spots, in varying the size of the information carrier 101.

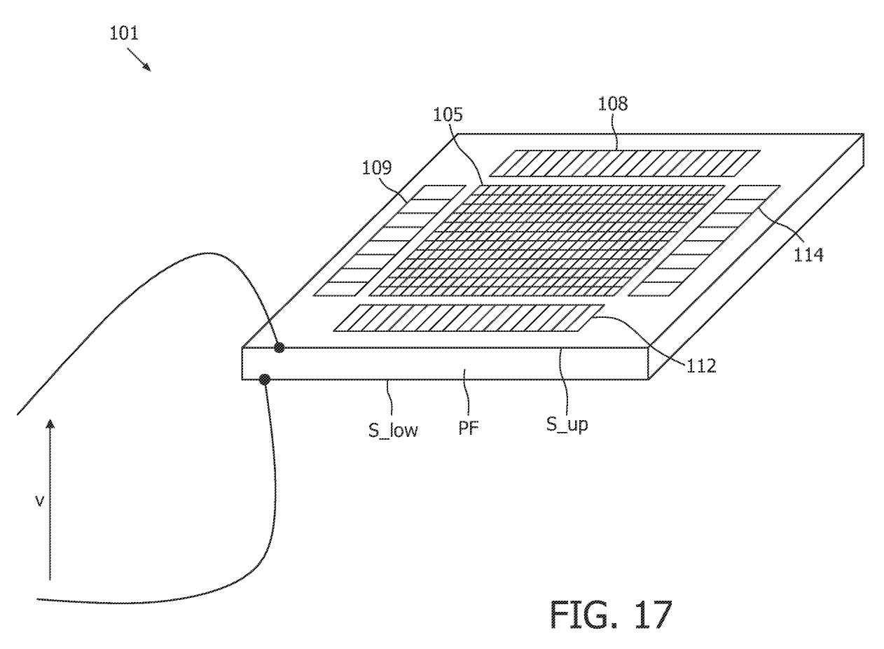

To this end as illustrated in FIG. 17, the information carrier 101 comprises a transparent layer (PF) made of a polymer film comprising an upper surface S_up and a lower surface S_low. The polymer film is intended to receive a voltage difference V between the two surfaces. When the voltage difference V is applied between the two surfaces, the Maxwell stress phenomenon causes the polymer film to lengthen in planar direction, varying the period S of the periodic structures.

The voltage difference V is a signal generated by a loop-control, and derived from a difference between the targeted period s0 and the measured period s.

As a consequence, the polymer film acts as third actuation means for adjusting the period s of said first, second, third or fourth periodic structure 108, 109, 112, 114, from control signals derived from the measure of said period s.

In the above description, it is assumed that the quality of the light spots applied to the information carrier 101 was well focussed (i.e. small light spots having a high contrast) such that the array of light spots 103 is equivalent to a sampling operation. In practice, it may occur that the light spots are not perfectly focussed, to the detriment of the data reading in the data area 105. It is thus an important issue to measure the focus, and to vary accordingly along axis z the distance between the information carrier 101 and the optical element 102 generating the array of light spots 102.

The Moiré magnification can be considered as a convolution of a magnification of the periodic structure with a magnification of the array of light spots itself. As a consequence, when the light spots are well focussed, the different Moiré patterns have a blurred appearance. On the contrary, when the light spots are well focussed, the different Moiré patterns have a sharp appearance.

It is thus proposed to control the focus of the light spots in first analysing the sharpness of the Moiré patterns detected on the detector 106, then in varying along axis z the distance between the information carrier 101 and the optical element 102, until measuring a maximum contrast in one or a plurality of Moiré patterns.

The contrast of the Moiré patterns can be done with an algorithm based on a gradient measure, or alternatively with an algorithm based on a histogram. To this end, the processing unit 116 comprises fourth analysis means 121 for deriving a contrast value of at least one of said first, second, third or fourth Moiré patterns.

The distance between the information carrier 101 and the optical element 102 is varied by third actuation means AC6 (e.g. a piezoelectric actuator).

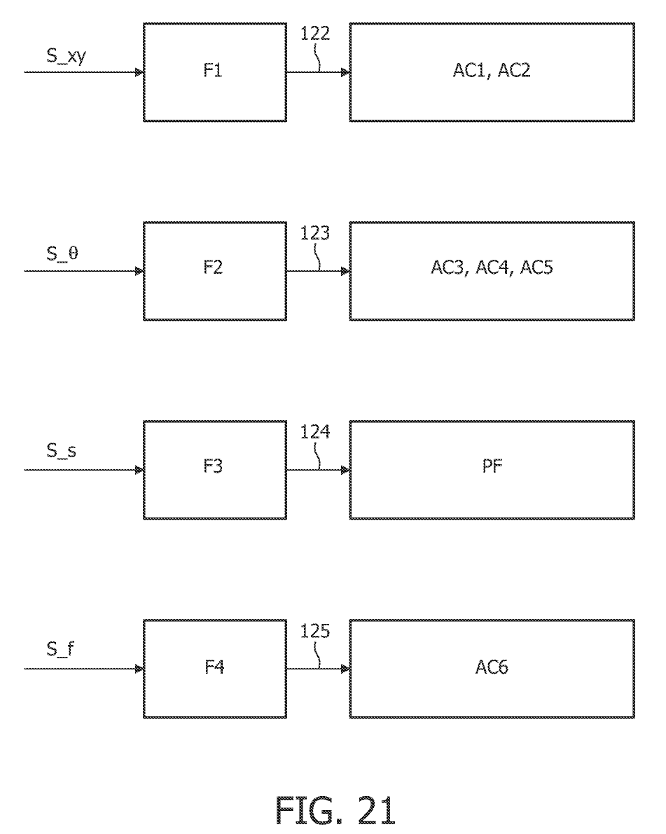

Thus, the Moiré servo marks on the data card can be used for focus detection. The Moiré servo marks generate a Moiré magnified image of the spot. The size of this image is minimal, and the contrast is maximal, when the data layer is in the focal plane of the spots. FIG. 21 depicts the principle of the loop-controls performed by the processing unit 116 for controlling the system depicted in FIG. 1.

For adjusting the spatial position (x,y) of the information carrier 101 with respect to the array of light spots 103, a signal S_xy reflecting the spatial position (x,y) is passed through a first low-pass filter F1 intended to generate controls signals 122 generated by the processing unit 116 to the actuations means AC1-AC2. In response, the actuation means AC1-AC2 correct their spatial position. The optimal position between the information carrier and the array of light spots is reached when the measured spatial position corresponds to a targeted spatial position.

For adjusting the angular position θ of the information carrier 101 with respect to the array of light spots 103, a signal S_θ reflecting the value of angle θ is passed through a second low-pass filter F2 intended to generate control signals 123 generated by the processing unit 116 to the actuations means AC1-AC2-AC3. In response, the actuations means AC1-AC2-AC3 correct their angular position, which modifies the measured angle θ. The optimal alignment between the information carrier and the array of light spots is reached when angle θ tends to zero.

For adjusting the period s of the structures printed on the information carrier 101, a signal S_s reflecting the value of said period s is passed through a third low-pass filter F3 intended to generate control signals 124 generated by the processing unit 116 to the actuations means PF. In response, the actuations means PF elongate, which modifies the size of the information carrier 101 as well as the measured period s. The optimal period s of the information carrier is reached when it tends to a targeted period s0.

For adjusting the focus of the array of light spots 103 applied to the information carrier 101, a signal S_f reflecting a measure of the focus is passed through a fourth low-pass filter F4 intended to generate control signals 125 generated by the processing unit 116 to the actuations means AC6. In response, the actuation means AC6 move along axis z the height of the information carrier 101. The optimal focus of the light spots is reached when the contrast of said first, second, third or fourth Moiré patterns is maximum.

In the arrangement described above, although the contrast of a captured image can be used as a measure of the (de)focus during positioning of the data layer of the data card in the focal plane of the probes, the resultant error signal is unidirectional, i.e. it does not give information on whether a negative or positive correction of the position of the data card is necessary. In accordance with the following exemplary embodiments of the invention, it is proposed to have a dedicated part of the probe array at a different plane to that of the probes used for data read-out. In this manner, a directional error signal can be obtained.

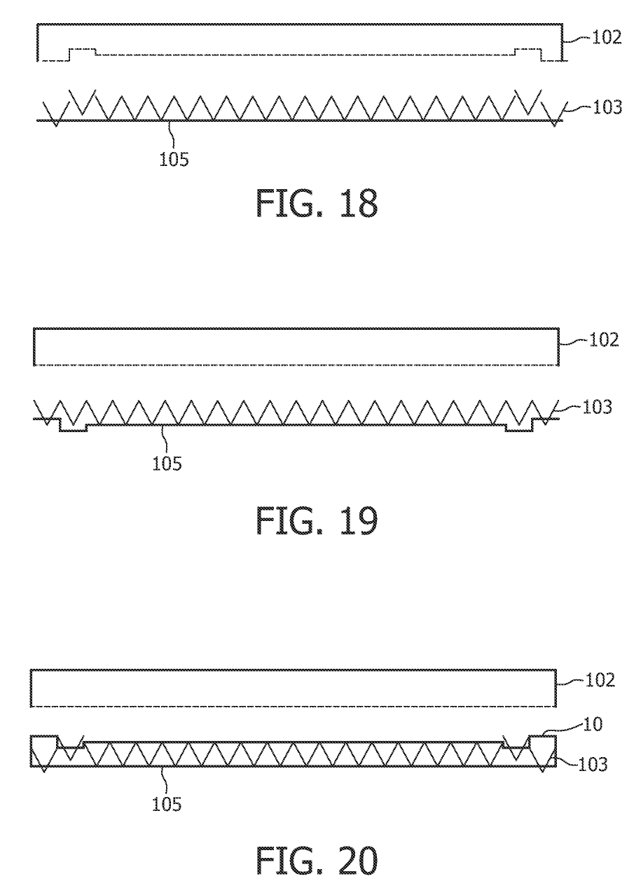

Referring to FIG. 18 of the drawings the probe generation device 102 has a phase/amplitude structure for generating an array of probes 103, and is designed in such a way that some of the probes are at a higher z-position and same as at a lower z-position. As such, in the illustrated example, the phase/amplitude structure which produces the probes may be displaced along the z-axis at the rims or edges of the structure such that this displaced part of the structure produces the displaced spots.

Referring to FIG. 19 of the drawings, in a second exemplary embodiment of the invention, the probe generation device 102 is designed in such a way that all the spots 103 are in the same plane (uniform z-distance). In this case, part of the data layer structure 105 is positioned at a higher z-position and part of it is positioned at a lower z-position. More particularly, in the illustrated embodiment, the displaced parts of the data layer 105 (at the rims or edges thereof) result in defocused spots 103.

Referring to FIG. 20 of the drawings, in a third exemplary embodiment of the invention, the probe generation device is designed in such a way that all the spots 103 are in the same plane, and the data layer 105 is also in one plane. In this case, a layer 10 of transparent material is provided in the space between the probe generation device 102 and the data layer 105 in order to accomplish the required defocusing. It is clear from the illustrated example, that the parts (at the rims or edges) where the thickness of the transparent substrate 10 deviates from the mean value result in defocused spots 103.

Thus, the present invention extends the focus detection system by adding a sign to the error signal, enabling the use of a proportional controlling scheme for the focus actuation. The contrast signal is analog, and hence a proportional controller can be used to control the z-position of the data card. The object of the invention is achieved by having a dedicated part of the probe array at a different plane to that of the probes for the data read-out. In this way, a directional error signal can be obtained.

The system according to the invention can advantageously be implemented in an apparatus for reading and/or writing data on an information carrier as previously described.

Preferably, when the invention is implemented in such an apparatus, the focus of the light spots is first measured and corrected, then the misalignment angle between the array of light spots and the information carrier is measured and corrected. These two steps have to be done prior to a read or write operation of the data area. Then the spatial position measurement and adjustment can be performed during read or write operations.

The system in accordance with the invention may be used in a microscope. Microscopes with reasonable resolution are expensive, since an aberration-free objective lens with a reasonably large field of view and high enough numerical aperture is costly. Scanning microscopes solve this cost issue partly by having an objective lens with a very small field of view, and scanning the objective lens with respect to the sample to be measured (or vice-versa). The disadvantage of this single-spot scanning microscope is the fact that the whole sample has to be scanned, resulting in cumbersome mechanics. Multi-spot scanning microscopes solve this mechanical problem, since the sample does not have to be scanned over its full dimensions, the scanning range is limited to the pitch between two spots.

In a microscope in accordance with the invention, a sample is illuminated with the spots that are created by the probe array generating means, and a camera takes a picture of the illuminated sample. By scanning the spots over the sample, and taking pictures at several positions, high-resolution data are gathered. A computer may combine all the measured data to a single high-resolution picture of the sample. The system in accordance with the invention allows to accurately and reliably positioning the information carrier carrying the sample with respect to the array of light spots.

A microscope in accordance with the invention consists of an illumination device, a probe array generator, a sample stage, optionally an imaging device (e.g. lens, fiber optic face plate, mirror), and a camera (e.g. CMOS, CCD). This system corresponds to the system of FIG. 1, wherein the information carrier (101) is a microscope slide on which a sample to be imaged may be placed, the microscope slide being deposited on a sample stage. The microscope slide comprises periodic structures such as structures 108, 109 and 112. The data sample is placed on the information carrier at a location where there is no such periodic structure.

Light is generated in the illumination device, is focused into an array of foci by means of the probe array generator, it is transmitted (partly) through the sample to be measured, and the transmitted light is imaged onto the camera by the imaging system. The sample is positioned in a sample stage, which can reproducibly move the sample in the focal plane of the foci and perpendicular to the sample. In order to image the whole sample, the information carrier is scanned so that all areas of the sample are imaged by an individual probe. The positioning servo is performed by means of the reference structures and the windowing process as described hereinbefore.

Instead of a transmissive microscope as described above, a reflective microscope may be designed. In a reflective microscope in accordance with the invention, light that has passed through the sample is reflected by a reflecting surface of the microscope slide and then redirected to the camera by means of a beam splitter.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A system for scanning an information carrier (101) comprising one or more servo marks, the system comprising: —probe array generation means (104, 102) for generating a probe array comprising an array of light spots (103) intended to be applied to said information carrier (101) so as to generate output beams representative of said one or more servo marks (108, 109), wherein the distance between the focal point of one or more light spots of a portion of said probe array and a respective portion of said information carrier corresponding to at least one servo mark is different to the distance between the focal points of the light spots of the rest of the probe array and the rest of said information carrier; an image sensor (106) for receiving said output beams and generating a corresponding image; —means (116) for deriving a contrast value in respect of at least a portion of said image corresponding to said at least one servo mark (108, 109) and generating a control signal (125) derived from said contrast value, said control signal (125) being for application to actuation means (AC6) for adjusting the distance between said information carrier (101) and said array of light spots (103).

2. A system according to claim 1, wherein said servo marks comprise one or more periodic structures (108, 109) intended to interfere with the array of light spots (103) so as to generate one or more respective Moire patterns on the image sensor (106).

3. A system according to claim 1, wherein a contrast value is derived in respect of at least one of said Moire patterns in order to generate a control signal (125) for controlling the focus of the light spots (103) applied to the information carrier.

4. A system according to claim 1, wherein the probe array generation means comprises a phase/amplitude structure (102) for generating the probe array (103), and wherein the phase/amplitude structure (102) is displaced at said portion thereof corresponding to at least one servo mark (108, 109) along a plane substantially perpendicular to the plane of the information carrier, such that the focal points of the light spots (103) generated by said portion of said phase/amplitude structure (102) are at a different plane to that of the rest of the light spots (103) of said probe array.

5. A system according to claim 4, wherein said at least one servo mark (108, 109) is positioned at or adjacent an edge of a data layer (105) of the information carrier and the displaced portion of the phase/amplitude structure (102) corresponds to said position at or adjacent said edge of the data layer (105).

6. A system according to claim 1, wherein the profile of the information carrier (101) is non-uniform at a portion thereof, such that the focal point of the light spots (103) relative to the information carrier (101) is different at said portion to that of the rest of the light spots (103).

7. A system according to claim 6, wherein said at least one servo mark (108, 109) is positioned at or adjacent an edge of a data layer (105) of the information carrier and the non-uniform portion of the information carrier (101) corresponds to said position at or adjacent said edge of the data layer (105).

8. A system according to claim 1, wherein a substrate (10) is provided between the probe array (103) and the information carrier (101), an optical property of which substrate (10) is non-uniform at a portion thereof, such that the focal point of the light spots (103) relative to the information carrier (101) is different at a position corresponding to said portion to that of the rest of the light spots (103).

9. A system according to claim 8, wherein said at least one servo mark (108, 109) is positioned at or adjacent an edge of a data layer (105) of the information carrier and the portion of the substrate (10) at which an optical property thereof is varied such that the focal point of the light spots (103) relative to the information carrier (101) is different at said portion to that of the rest of the light spots (103) corresponds to said position at or adjacent said edge of the data layer (105).

10. A system according to claim 9, wherein said substrate (10) is beneficially substantially transparent, and the thickness thereof is non-uniform at said portion thereof so as to attain said non-uniform optical property, such that the focal point of the light spots (103) relative to the information carrier (101) is different at said portion to that of the rest of the light spots (103).

11. A method of scanning an information carrier (101) wherein the information carrier (101) comprises one or more servo marks (108, 109), the method comprising the steps of: —generating a probe array comprising an array of light spots (103), wherein the distance between the focal point of one or more light spots of a portion of said probe array and a respective portion of said information carrier corresponding to at least one servo mark is different to the distance between the focal points of the light spots of the rest of the probe array and the rest of said information carrier; applying said probe array to said information carrier (101) so as to generate output beams representative of said one or more servo mark (108, 109); providing an image sensor (106) for receiving said output beams and generating a corresponding image; and —deriving a contrast value in respect of at least a portion of said image corresponding to said at least one servo mark (108, 109) and generating a control signal (125) derived from said contrast value, said control signal (125) being for application to actuation means (AC6) for adjusting the distance between said information carrier (101) and said array of light spots (103) and thereby controlling the focus of the light spots (103) applied to said information carrier.

12. A microscope comprising a system as claimed in claim 1.
